(19) United States
(12) Patent Application Publication
(10) Pub. No.: US 2004/0027800 A1
(43) Pub. Date: Feb. 12, 2004

(54) Electronic apparatus with a pump to force out liquid coolant

(75) Inventors: Mitsuyoshi Tanimoto, Sagamihara-shi (JP); Yoshinori Kamikawa, Akishima-shi (JP); Fumihiko Koizumi, Tachikawa-shi (JP); Teruo Kinoshita, Nishitama-gun (JP)

Correspondence Address: Pillsbury Winthrop LLP, Intellectual Property Group, Suite 2800, 725 South Figueroa Street, Los Angeles, CA, 90017-5406, US

(73) Assignee: Kabushiki Kaisha Toshiba, Tokyo (JP)

(21) Appl. No.: 10/411,411

(22) Filed: Apr. 10, 2003

(30) Foreign Application Priority Data
Aug. 7, 2002 (JP) 2002-230128

(51) Int. Cl. G06F 1/20

(52) U.S. Cl. 361/687; 361/697

(57) ABSTRACT

An electronic apparatus includes a housing, a heat-receiving portion thermally connected to a heat-generating component, a heat-radiating portion for radiating heat generated by the component, a pump for supplying liquid coolant to the heat-radiating portion, and a holding member secured to fixing portions and holding the pump in the housing. The pump has a plurality of peripheral walls. A plurality of fixing areas are provided outside the pump, each being located between two corners defined by an adjacent three of the peripheral walls. The fixing portions are aligned with the fixing areas.

### CROSS-REFERENCE TO RELATED APPLICATIONS

This application is based upon and claims the benefit of priority from prior Japanese Patent Application No. 2002-230128, filed Aug. 7, 2002.

### BACKGROUND OF THE INVENTION

1. Field of the Invention

The present invention relates to an electronic apparatus having a heat-generating component such as a semiconductor package, which is cooled with a liquid coolant. More particularly, the invention relates to a pump that supplies coolant under pressure and the structure of the heat-receiving portion that receives heat from the heat-generating component.

2. Description of the Related Art

Microprocessors for use in notebook-type portable computers generate more heat while operating, as they process data at higher speeds and perform more functions. Recently, so-called liquid-cooled cooling systems have been developed to cool the microprocessors. Each cooling system uses a liquid coolant that has a specific heat far greater than that of air.

Japanese Patent Application KOKAI Publication No. 7-142886 discloses a liquid-cooled cooling system for use in portable computers. The cooling system comprises a heat-receiving header, a heat-radiating header, and a coolant-circulating tube. The heat-receiving header is provided in the housing of the portable computer and is thermally connected to the microprocessor. The heat-radiating header is incorporated in the display unit of the portable computer. The coolant-circulating tube extends between the housing and the display unit and connects the heat-receiving header and the heat-radiating header.

In the cooling system, the heat-receiving header receives the heat that the microprocessor has generated. The heat-receiving header heats the coolant, which is transferred to the heat-radiating header via the tube. The heat-radiating header radiates the heat as the coolant passes through it. The coolant is cooled due to the heat exchanging at the heat-radiating header and flows back into the heat-receiving header via the coolant-circulating tube. In the heat-receiving header, the coolant receives the heat generated by the microprocessor. As the coolant is circulated, the heat emanating from the microprocessor efficiently propagates to the heat-radiating header. The microprocessor can be cooled with high efficiency.

Conventional cooling systems of this type comprise a small pump that is provided in the middle part of the coolant-circulating tube. The pump is designed to supply the coolant under pressure. The pump has a pump housing and an impeller provided in the pump housing. The pump housing looks rectangular as seen in the axial direction of the impeller. It has four right-angle corners.

The four corners of the pump housing lie outside the circular locus of the outer vane-edges of the impeller. Hence, the pump housing has “dead spaces” in the corners, which do not work to apply pressure to the coolant. Having these dead spaces, the pump housing is larger than is necessary.

Consequently, the printed circuit board of the portable computer needs to have a large area for holding the pump. In other words, the pump occupies so large an area that the mounting area for many circuit components is inevitably limited.

### BRIEF SUMMARY OF THE INVENTION

An embodiment of the invention is to provide an electronic apparatus that incorporates a small pump or a small heat-receiving portion, making it possible to arrange more components in the housing than otherwise.

According to one aspect of the invention, there is provided an electronic apparatus that includes a housing that contains a heat-generating component. A heat-receiving portion is thermally connected to the heat-generating component. A heat-radiating portion radiates heat generated by the heat-generating component. A coolant-circulating path circulates liquid coolant between the heat-receiving portion and the heat-radiating portion. A pump supplies the coolant to the heat-radiating portion and has a plurality of peripheral walls. A plurality of escape spaces/fixing areas are provided outside the pump, each escape space/fixing areas being located between two corners defined by adjacent three of the peripheral walls. A plurality of fixing portions are arranged around the pump and aligned with the escape spaces/fixing areas. And, a holding member is fastened to the fixing portions and holds the pump in the housing.

Thus, the pump has no dead spaces and can be smaller than otherwise. Being small, the pump does not limit the space for accommodating the other components in the housing of the apparatus.

Additional embodiments and advantages of the invention will be set forth in the description which follows, and in part will be obvious from the description, or may be learned by practice of the invention. The embodiments and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view of a portable computer that is a first embodiment of the invention, showing a positional relation of the pump, a heat-radiating portion, and a coolant-circulating path;

FIG. 2 is a perspective view of the first embodiment, depicting the display unit rotated to the open position;

FIG. 3 is a cross-sectional view of the first embodiment, showing the positional relation of the pump, heat-radiating portion, and coolant-circulating path;

FIG. 4 is a cross-sectional view of the heat-radiating portion of the first embodiment;

FIG. 5 is a perspective view of the first embodiment, illustrating the pump secured to the printed circuit board;

FIG. 6 is a cross-sectional view of the first embodiment, showing the pump formed integral with the heat-receiving portion and secured by a holding member to the printed circuit board;

FIG. 7 is a plan view of the pump incorporated in the first embodiment;

FIG. 8 is a cross-sectional view of a portable computer that is a second embodiment of the invention, representing the positional relation of the heat-receiving portion, pump, heat-radiating portion, and coolant-circulating path;

FIG. 9 is a cross-sectional view of the second embodiment, displaying the heat-receiving portion secured by the first holding member to the printed circuit board;

FIG. 10 is a plan view of the heat-receiving portion of the second embodiment;

FIG. 11 is a cross-sectional view of the second embodiment, depicting the pump secured by the second holding member to the printed circuit board;

FIG. 12 is a plan view of the pump incorporated in the second embodiment;

FIG. 13 is a plan view of the pump incorporated in a third embodiment of the invention; and

FIG. 14 is a plan view of the pump incorporated in a fourth embodiment of the present invention.

### DETAILED DESCRIPTION OF THE INVENTION

The first embodiment of the invention will be described, with reference to FIGS. 1 to 7.

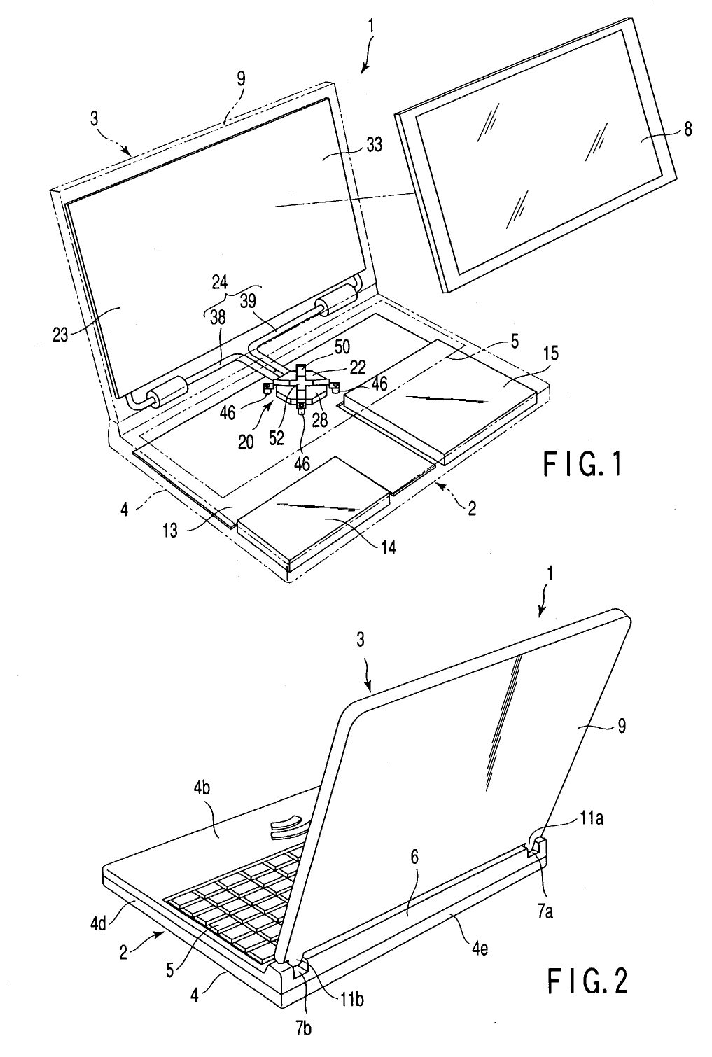

FIGS. 1 and 2 show a portable computer 1 that is an electronic apparatus according to this invention. The portable computer 1 comprises a computer main body 2 and a display unit 3. The main body 2 has a housing 4 that is shaped like a flat box. The housing 4 has a bottom wall 4a, a top wall 4b, a front wall 4c, left and right side walls 4d and a rear wall 4e. The top wall 4b supports a keyboard 5.

The top wall 4b has a display supporting section 6 that is located at the back of the keyboard 5. The display supporting section 6 extends in the width direction of the housing 4 and protrudes upwards from the rear edge of the top wall 4b. The section 6 has a pair of recesses 7a and 7b. The recesses 7a and 7b are spaced apart from each other in the width direction of the housing 4.

The display unit 3 comprises a liquid-crystal display panel 8 and a display housing 9. The display housing 9 contains the display panel 8 and has a pair of hollow legs 11a and 11b. The legs 11a and 11b are inserted in the recesses 7a and 7b of the housing 4. Hinges (not shown) fasten the legs 11a and 11b to the rear edge of the housing 4. Thus, the display unit 3 can be rotated between a closed position and an opened position. At the closed position the display unit 3 covers the keyboard 5 from above. At the opened position the display unit 3 stands upright, exposing the keyboard 5.

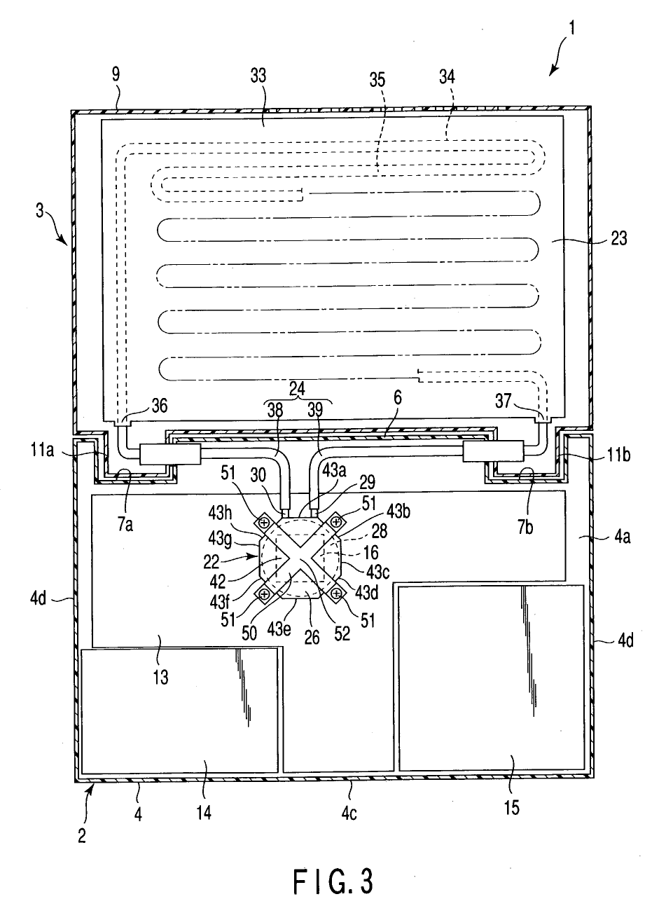

As FIGS. 1 and 3 show, the housing 4 incorporates a printed circuit board 13, a hard disk drive 14, and a CD-ROM drive 15. The printed circuit board 13, hard disk drive 14 and CD-ROM drive 15 are arranged on the bottom wall 4a of the housing 4.

As FIG. 6 depicts, a semiconductor package 16 is soldered to the upper surface of the printed circuit board 13. The package 16 is a circuit component that generates heat while operating. It lies at the back of the printed circuit board 13. It has a base substrate 17 and an IC chip 18. The IC chip 18 is mounted on the center part of the base substrate 17. The IC chip 18 generates much heat while operating, because it processes data at high speeds and performs many functions. The IC chip 18 must be cooled to operate reliably as desired.

As FIGS. 1 and 3 show, the portable computer 1 incorporates a liquid-cooled cooling unit 20. The cooling unit 20 includes a heat-receiving portion 21, a pump 22, a heat-radiating portion 23, and a coolant-circulating path 24.

As is illustrated in FIG. 6, the heat-receiving portion 21 is a metal plate. The heat-receiving portion 21 is larger than the base substrate 17 of the semiconductor package 16. Thus, the portion 21 covers the IC chip 18 from above. The IC chip 18 is thermally connected to the center part of the lower surface of the heat-receiving portion 21.

The pump 22 is formed integral with the heat-receiving portion 21. The pump 22 includes an impeller 25 and a pump housing 26. The impeller 25 is coupled with a flat motor 27, which is secured to the pump housing 26. The impeller 25 has an axis R1 that extends in the direction of thickness of the housing 4. The flat motor 27 starts rotating the impeller 25 when the power switch on the portable computer 1 is turned on or when the temperature of the semiconductor package 16 rises to a predetermined value.

The pump housing 26 has a pump chamber 28, in which the impeller 25 is provided. As FIG. 7 depicts, the pump chamber 28 has a circular inner surface that extends along the locus of the outer vane-edges of the impeller 25. The pump housing 26 has a coolant inlet port 29 and a coolant outlet port 30. Both ports 29 and 30 communicate with the pump chamber 28.

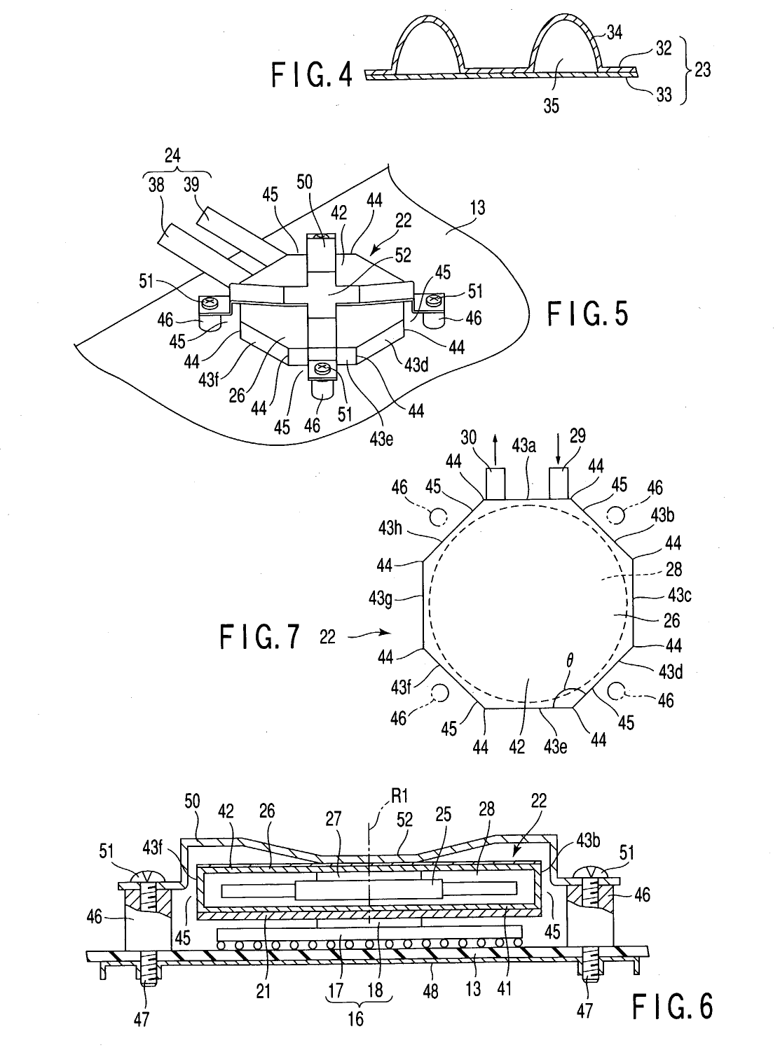

As shown in FIGS. 1 and 3, the heat-radiating portion 23 is interposed between the liquid-crystal display panel 8 and the back of the display housing 9. The heat-radiating portion 23 is a rectangular plate that has almost the same size as the liquid-crystal display panel 8. As FIG. 4 shows, the heat-radiating portion 23 includes two heat-radiating plates 32 and 33. Both heat-radiating plates 32 and 33 are made of metal that excels in thermal conductivity. They are laid one upon the other.

The first heat-radiating plate 32 has a swelling portion 34 that project away from the second heat-radiating plate 33. The swelling portion 34 is meandering and has a U-shaped cross section. The swelling portion 34 opens to the second heat-radiating plate 33. The second heat-radiating plate 33 closes the open end of the swelling portion 34. The swelling portion 34 and the second heat-radiating plate 33 therefore define a coolant path 35, which is meandering.

The heat-radiating portion 23 has a coolant inlet port 36 and a coolant outlet port 37. The coolant inlet port 36 is located at the left end of the heat-radiating portion 23 and connected to the upstream end of the coolant path 35. The coolant inlet port 36 lies adjacent to the left leg 11a of the display housing 9. The coolant outlet port 37 is connected to the downstream end of the coolant path 35 and located on the right side of the heat-radiating portion 23. The port 37 lies adjacent to the right leg 11b of the display housing 9. Therefore, the ports 36 and 37 are spaced apart from each other in the widthwise direction of the display housing 9.

As FIGS. 1 and 3 show, the coolant-circulating path 24 includes two pipes 38 and 39. The first pipe 38 connects the coolant outlet port 30 of the pump housing 26 and the coolant inlet port 36 of the heat-radiating portion 23. The first pipe 38 extends from the interior of the housing 4 into the display housing 9, passing through the display supporting section 6 and the left leg 11a. The second pipe 39 connects the coolant inlet port 29 of the pump housing 26 and the coolant outlet port 37 of the heat-radiating portion 23. The second pipe 39 extends from the interior of the housing 4 into the display housing 9, passing through the display supporting section 6 and the right leg 11b.

The pump chamber 28, the coolant-circulating path 24, and the coolant path 35 of the heat-radiating portion 23 are filled with coolant liquid. The coolant liquid is, for example, antifreeze prepared by adding ethylene glycol solution and, if necessary, corrosion inhibitor, to water.

As FIGS. 5 to 7 illustrate, the pump housing 26 is a flat octagonal box and made of thermal conductive metal such as aluminum alloy. The pump housing 26 has a bottom wall 41, a top wall 42 and eight peripheral walls 43a to 43h. The bottom wall 41 lies on the upper surface of the heat-receiving portion 21 and is thus thermally connected to the heat-receiving portion 21. The top wall 42 opposes the bottom wall 41. The impeller 25 is positioned between the bottom wall 41 and top wall 42 of the pump housing 26. The first to eighth peripheral walls 43a to 43h surround the impeller 25 and fasten the edge of the bottom wall 41 and the edge of the top wall 42 together. The first to eighth peripheral walls 43a to 43h extend tangent to the circular inner surface of the pump chamber 28.

The pump housing 26 has eight corners 44. The corners 44 are defined by eight peripheral walls 43a to 43h, each by two adjacent peripheral walls. The corners 44 have an angle θ of 135°. Hence, the pump housing 26 looks octagonal as viewed in the axial direction of the axis R1 of the impeller 25.

The shape of the pump housing 26 will be described in detail. The first peripheral wall 43a, third peripheral wall 43c, fifth peripheral wall 43e and seventh peripheral wall 43g lie in vertical planes that extend at right angles to one another. The second peripheral wall 43b, fourth peripheral wall 43d, sixth peripheral wall 43f and eighth peripheral wall 43h incline to the first, third, fifth and seventh peripheral walls 43a, 43c, 43e and 43g, respectively, and extend tangent to the circular inner surface of the pump chamber 28.

Thus, the second peripheral wall 43b, fourth peripheral wall 43d, sixth peripheral side wall 43f and eighth peripheral wall 43h provide four escape spaces/fixing areas 45 outside the pump housing 26. Each escape space 45 is located between two adjacent corners 44. The spaces 45 are shaped like four corners cut from a square box. The spaces 45 lie on the diagonals of the semiconductor package 16. They oppose one another across the impeller 25. Thus, the escape spaces 45 and the first, third, fifth and seventh peripheral walls 43a, 43c, 43e and 43g are alternately arranged around the impeller 25.

The coolant inlet port 29 and coolant outlet port 30 of the pump housing 26 are made in the first peripheral wall 43a of the pump housing 26. The ports 29 and 30 extend parallel to each other and open at the back of the housing 4.

The pump 22, which looks octagonal, is fixed to the upper surface of the printed circuit board 13. How the pump 22 is fixed will be described, with reference to FIGS. 5 and 6. Fixing portions includes four stud pins 46. The stud pins 46 are secured to the printed circuit board 13. The stud pins 46 lie outside the semiconductor package 16 and on the diagonals of the package 16. They have a screw 47 at one end. The screw 47 penetrates the printed circuit board 13 and is driven into a reinforcing plate 48 that lies on and is fastened to the lower surface of the printed circuit board 13.

The stud pins 46 protrude upwards from the upper surface of the printed circuit board 13. They are aligned with the escape spaces 45. In other words, they extend in the escape spaces 45 and along the second, fourth, sixth and eighth peripheral walls 43b, 43d, 43f and 43h of the pump housing 26, respectively.

Screws 51 fasten a holding member 50 to the tops of the stud pins 46. The holding member 50 is a leaf spring, and its center part is a pushing portion 52. The pushing portion 52 pushes the top wall 42 of the pump housing 26 downwards. The pump housing 26 is thus clamped between the semiconductor package 16 and the holding member 50. The pump 22 is therefore held immovable on the printed circuit board 13.

The IC chip 18 of the semiconductor package 16 generates heat while the portable computer 1 is operating. The heat emanating from the IC chip 18 propagates via the heat-receiving portion 21 to the bottom wall 41 of the pump housing 26. As indicated above, the pump housing 26 has the pump chamber 28 that is filled with liquid coolant. The liquid coolant absorbs a greater part of the heat transferred to the pump housing 26.

When the impeller 25 of the pump 22 rotates, the liquid coolant is pumped from the pump chamber 28 into the heat-radiating portion 23 through the first pipe 38. The liquid coolant then circulates through the pump chamber 28 and the heat-radiating portion 23.

More precisely, the liquid coolant heated in the pump housing 26 flows through the coolant path 35 that is meandering in the heat-radiating portion 23. While the liquid coolant is flowing through the path 35, the heat diffuses into the first heat-radiating plate 32 and second heat-radiating plate 33. Subsequently, the heat is radiated from the surfaces of these plates 32 and 33.

The liquid coolant is cooled while flowing through the coolant path 35. The coolant thus cooled flows back into the pump chamber 28 via the second pipe 39. While so flowing, the coolant absorbs the heat from the IC chip 18. The coolant is then supplied to the heat-radiating portion 23. This circulation of the coolant is repeated, radiating the heat of the IC chip 18 from the portable computer 1.

The pump 22, which functions to receive the heat from the IC chip 18, as well, has an octagonal housing 26. The eight corners 44 of the pump housing 26 have an angle θ of 135°. Since the angle θ is greater than the right angle, the pump housing 26 is circular, rather than square. The corners 44 less project outwards in radial direction of the housing 26 than otherwise. Thus, there are no dead spaces in the corners of the pump housing 26. This renders the pump housing 26 small. The housing 26 occupies but a small area in a horizontal plane.

As described earlier, the escape spaces/fixing areas 45 in the pump housing 26 are shaped like four corners cut from a square box. The four stud pins 46 are provided in the escape spaces 45, respectively, securing the pump 22 to the printed circuit board 13. Provided in the escape spaces 45, the two stud pins 46 arranged in each diagonal of the semiconductor package 16 are spaced apart but by a short distance. Since the pump housing 26 occupies a small area and the distance between the stud pins 46 is short, a large area need not be provided on the printed circuit board 13 or a large space need not be provided in the housing 4, in order to accommodate the pump 22.

The first peripheral wall 43a of the octagonal pump housing 26 has the coolant inlet port 36 and coolant outlet port 37. Thus, both ports 36 and 37 can be oriented in eight different directions, from one direction to the next direction by rotating the pump housing 26 through 45° around the axis R1 of the impeller 25. As a result, the direction in which to lead the first and second pipes 38 and 39 can be adjusted with great freedom. This arrangement makes it easy to arrange the coolant-circulating path 24 in the housing 4.

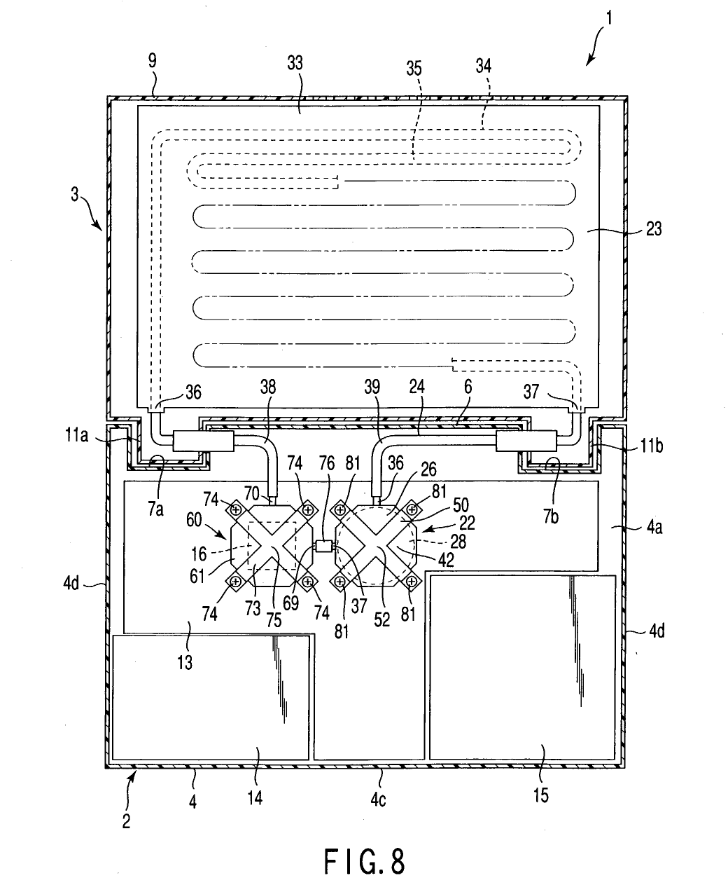

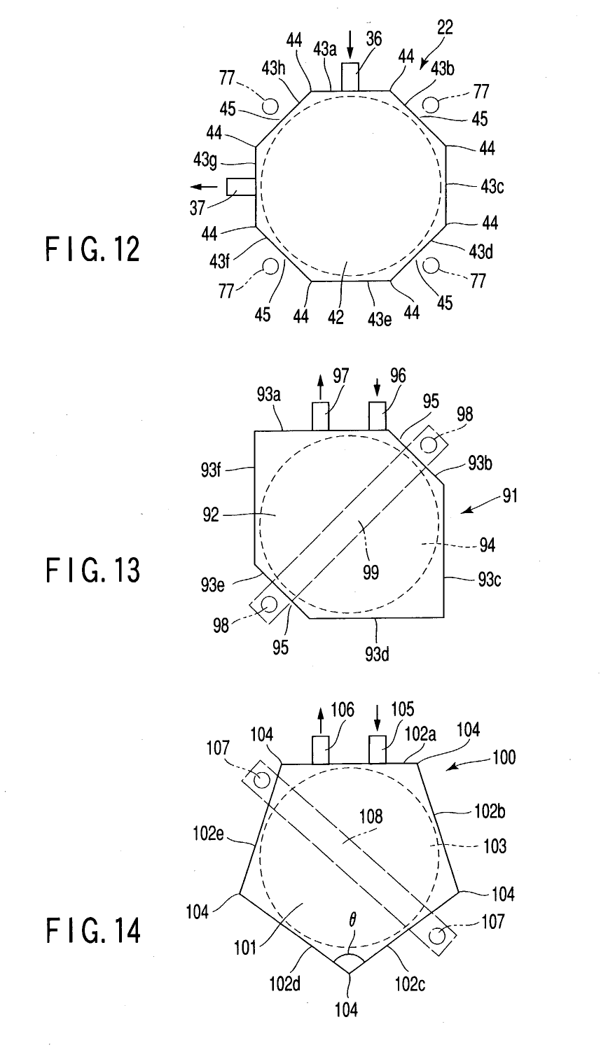

The present invention is not limited to the first embodiment described above. FIGS. 8 to 12 show the second embodiment of this invention.

The second embodiment differs from the first embodiment in that the pump 22 for supplying the liquid coolant and a heat-receiving portion 60 for receiving heat from the semiconductor package 16 are spaced apart from each other. The second embodiment is identical to the first in any other structural features. The components identical to those of the first embodiment are designated at the same reference numerals and will not be described in detail.

As FIGS. 8 to 10 depict, the heat-receiving portion 60 has a case 61 that is shaped like a flat box. The case 61 is made of thermally conductive metal such as aluminum alloy. The case 61 has a bottom wall 62, a top wall 63 and eight peripheral walls 64a to 64h. The lower surface of the bottom wall 62 is flat and serves as heat-receiving surface 65. The heat-receiving surface 65 is thermally connected to the IC chip 18 of the semiconductor package 16. The top wall 63 opposes the bottom wall 62. The first to eighth peripheral walls 64a to 64h fasten the edge of the bottom wall 62 and the edge of the top wall 63 together. Therefore, the walls 62, 63 and 64a to 64h constitute a coolant path 66 in the case 61. Coolant can flow in the coolant path 66. The coolant path 66 is thermally connected to the IC chip 18 by the bottom wall 62.

The first to eighth peripheral walls 64a to 64h surround the coolant path 66 and define the circumference of the case 61. The case 61 has eight corners 67. The corners 67 are defined by eight peripheral walls 64a to 64h, each by two adjacent peripheral walls. The corners 67 have an angle θ of 135°. The housing 61 is therefore octagonal.

To be more specific, the first peripheral wall 64a, third peripheral wall 64c, fifth peripheral wall 64e and seventh peripheral wall 64g lie in vertical planes that extend at right angles to one another. The second peripheral wall 64b, fourth peripheral wall 64d, sixth peripheral wall 64f and eighth peripheral wall 64h incline to the first, third, fifth and seventh peripheral walls 64a, 64c, 64e and 64g, respectively.

Thus, the second peripheral wall 64b, fourth peripheral wall 64d, sixth peripheral wall 64f and eighth peripheral wall 64h provide four escape spaces 68 outside the case 61. Each escape space 68 is located between two adjacent corners 67. The spaces 68 are shaped like four corners cut from a square box. The spaces 68 lie on the diagonals of the semiconductor package 16. They oppose one another across the coolant path 66.

The case 61 has a coolant inlet port 69 and a coolant outlet port 70. The coolant inlet port 69 is formed in the third peripheral wall 64c of the case 61 and communicates with the coolant path 66. The coolant outlet port 70 is formed in the first peripheral wall 64a and communicates with the coolant path 66. Thus, the ports 69 and 70 extend at right angles to each other. The coolant outlet port 70 opens to the back of the housing 4 and is connected to the first pipe 38 of the coolant-circulating path 24. The coolant inlet port 69 opens to the right side of the housing 4.

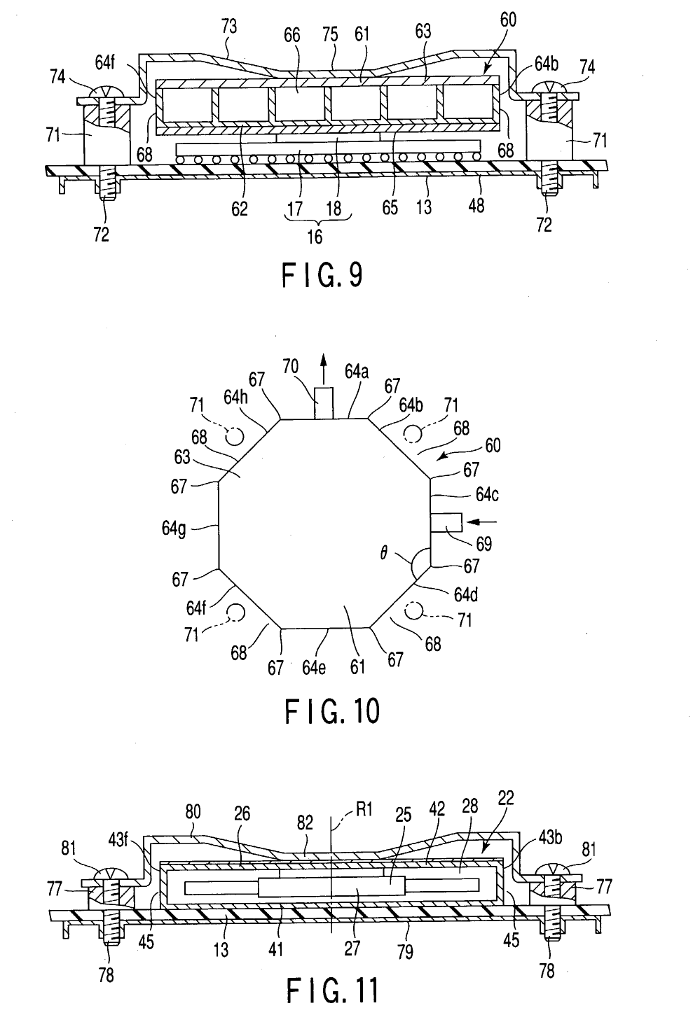

As FIG. 9 shows, the case 61 is secured to the printed circuit board 13, covering the semiconductor package 16 from above. First fixing portions includes four stud pins 71. The stud pins 71 are secured to the printed circuit board 13. The stud pins 71 lie outside the semiconductor package 16 and on the diagonals of the package 16. They have a screw 72 at one end. The screw 72 penetrates the printed circuit board 13 and is driven into the reinforcing plate 48.

The stud pins 71 protrude upwards from the upper surface of the printed circuit board 13. They are aligned with the escape spaces 68 that lie outside the case 61. In other words, they pass through the escape spaces 68 and oppose the second, fourth, sixth and eighth peripheral walls 64b, 64d, 64f and 64h of the case 61, respectively.

Screws 74 fasten a first holding member 73 to the tops of the stud pins 71. The first holding member 73 is a leaf spring, and its center part is a pushing portion 75. The pushing portion 75 pushes the top wall 63 of the case 61 downwards. The case 61 is thus clamped between the semiconductor package 16 and the first holding member 73. The heat-receiving portion 60 is therefore held immovable on the printed circuit board 13.

The pump 22 is located on the right side of the heat-receiving portion 60. The pump 22 has a pump housing 26 that is octagonal as in the first embodiment. The coolant inlet port 36 and coolant outlet port 37 of the pump 22 are made in the first peripheral wall 43a and seventh peripheral wall 43g of the pump housing 26, respectively. Hence, these ports 36 and 37 are positioned with their axes extending at right angles to each other.

The coolant inlet port 36 opens toward the back of the housing 4. It is connected to the second pipe 39 of the coolant-circulating path 24. The coolant outlet port 37 opposes the coolant inlet port 69 of the heat-receiving portion 60. A third pipe 76 connects the coolant outlet port 37 to the coolant inlet port 69.

As FIG. 11 shows, the pump 22 is secured to the upper surface of the printed circuit board 13. The pump 22 lies outside the semiconductor package 16 that is secured also to the upper surface of the printed circuit board 13. Second fixing portions includes four stud pins 77. The stud pins 77 are secured to the printed circuit board 13. The stud pins 77 are located on the diagonals of a square. They have a screw 78 at one end. The screw 78 penetrates the printed circuit board 13 and is driven into a reinforcing plate 79 that lies on and fastened to the lower surface of the printed circuit board 13.

The stud pins 77 protrude upwards from the upper surface of the printed circuit board 13. They are aligned with the escape spaces 45 that lie outside the pump housing 26. In other words, they pass through the escape spaces 45 and oppose the second, fourth, sixth and eighth peripheral walls 43b, 43d, 43f and 43h of the pump housing 26, respectively.

Screws 81 fasten a second holding member 80 to the tops of the stud pins 77. The second holding member 81 is a leaf spring, and its center part is a pushing portion 82. The pushing portion 82 pushes the top wall 42 of the pump housing 26 downwards. The pump housing 26 is thus clamped between the printed circuit board 13 and the second holding member 80. The pump 22 is therefore held immovable on the printed circuit board 13.

The heat that the IC chip 18 has generated propagates to the heat-receiving surface 65 of the case 61. A greater part of the heat is absorbed into the liquid coolant flowing in the coolant path 66 of the case 61.

When the impeller 25 of the pump 22 rotates, the liquid coolant is pumped from the pump chamber 28 into the coolant path 66 through the third pipe 76. The coolant is heated due to the heat exchanging at the coolant path 66 and supplied to the heat-radiating portion 23. The coolant then flows through the coolant path 35 that meanders. While the coolant is flowing through the path 35, the heat diffuses from the liquid coolant into the first heat-radiating plate 32 and the second heat-radiating plate 33. Ultimately, the heat is released from the surfaces of these plates 32 and 33.

The liquid coolant is cooled while flowing through the coolant path 35. The coolant thus cooled flows back into the pump chamber 28 via the second pipe 39. The liquid coolant further flows via the third pipe 76 to the coolant path 66 of the heat-receiving portion 60. While so flowing, the coolant absorbs the heat from the IC chip 18. This circulation of the coolant is repeated, radiating the heat of the IC chip 18 from the portable computer 1 via the heat-radiating portion 23.

In the second embodiment, the heat-receiving portion 60, which receives the heat from the IC chip 18, is octagonal. The eight corners 67 of the heat-receiving portion 60 have an angle θ of 135°. Since the angle θ is greater than the right angle, the heat-receiving portion 60 is circular, rather than square. The corners 67 less project outwards in radial direction of the case 61 than otherwise. Thus, there are no dead spaces in the corners of the case 61. This makes the case 61 small. The case 61 occupies but a small area in a horizontal plane.

In addition, four escape spaces 68 are provided outside the case 61, each located between two adjacent corners 67. The spaces 68 are shaped like four corners cut from a square box. The spaces 68 accommodate the four stud pins 71 that fasten and hold the heat-receiving portion 60. Provided in the escape spaces 68, the two stud pins 71 arranged in each diagonal of the semiconductor package 16 are spaced apart but by a short distance. Since the case 61 occupies a small area and the distance between the stud pins 71 is short, a large area need not be provided on the printed circuit board 13 or a large space need not be provided in the housing 4, in order to accommodate heat-receiving portion 60.

The four stud pins 77 are accommodated in the four escape spaces 45 that are provided outside the pump housing 26. Thus, a large area need not be provided on the printed circuit board 13 to accommodate the pump 22, as in the first embodiment.

FIG. 13 shows the third embodiment of the present invention. The third embodiment is characterized in that a pump housing 92 of a pump 91 is hexagonal. The pump housing 92 has six peripheral walls 93a to 93f. The peripheral walls 93a to 93f surround a circular pump chamber 94.

The first peripheral wall 93a and the sixth peripheral wall 93f lie in two vertical planes that extend at right angles. Similarly, the third peripheral wall 93c and the fourth peripheral wall 93d lie in two vertical planes that extend at right angles. The second peripheral wall 93b inclines to the first and third peripheral walls 93a and 93c and extends tangent to the circumference of the pump chamber 94. Similarly, the fifth peripheral wall 93e inclines to the fourth and sixth peripheral walls 93d and 93f and extends tangent to the circumference of the pump chamber 94. So inclining, the second peripheral wall 93b and the fifth peripheral wall 93e provide two escape spaces 95 outside the pump housing 92. The escape spaces 95 are shaped like two corners cut from a square box. They diametrically oppose across the pump chamber 94.

In the third embodiment, a coolant inlet port 96 and a coolant outlet port 97 protrude from the first peripheral wall 93a of the pump housing 92. The ports 96 and 97 extend parallel to each other, opening in the same direction.

Two stud pins 98, which function as fixing portions, are arranged in the escape spaces 95 provided outside the pump housing 92. The stud pins 98 project upward from the printed circuit board (not shown).

A band-shaped holding member 99 is fastened to the stud pin 98, extending from one stud pin 98 to the other stud pin 98. The holding member 99 pushes the pump housing 92 onto the printed circuit board (not shown).

Note that two escape spaces 95 accommodating the stud pins 98 are provided outside the pump housing 92 and positioned on a diagonal of the housing 92. The pump housing 92 can therefore be small, without reducing the size of the pump chamber 94.

The two stud pins 98 that fasten the pump 91 to the printed circuit board are provided in the escape spaces 95 provided outside the pump housing 92. Hence, not only the pump housing 92 can be small, but also the printed circuit board need not have a large area to hold the pump 91.

FIG. 14 depicts the fourth embodiment of this invention.

The fourth embodiment is characterized in that a pump housing 101 of a pump 100 is pentagonal. The pump housing 101 has five peripheral walls 102a to 102e. The peripheral walls 102a to 102e surround a circular pump chamber 103. They extend tangent to the circumference of the pump chamber 103. The pump housing 101 therefore has five corners 104. Each corner 104 is defined by two adjacent peripheral walls and has an angle θ of 110°.

In the fourth embodiment, both a coolant inlet port 105 and a coolant outlet port 106 are made in the first peripheral wall 102a of the pump housing 101. The ports 105 and 106 extend parallel and thus open in the same direction.

The third peripheral wall 102c and fifth peripheral wall 102e oppose each other across the pump chamber 103. Two stud pins 107 are provided outside the pump housing 101, at the third and fourth peripheral walls 102c and 102e, respectively. The stud pins 107, which function as fixing portions, protrude upwards from the printed circuit board (not shown).

A band-shaped holding member 108 is fastened to the stud pin 107, extending from one stud pin 107 to the other stud pin 107. The holding member 108 pushes the pump housing 101 onto the printed circuit board.

Since the pump housing 101 is pentagonal, it is circular, rather than square. The pump housing 101 therefore have no dead spaces outside the pump chamber 103. Thus, the pump housing 101 can be small, without reducing the size of the pump chamber 103.

In the present invention, the pump housing or the case of the heat-receiving portion may have more than eight peripheral walls. In other words, the pump chamber or the case may be, for example, decagonal. In this case, the pump housing or the case is more circular and more hardly have dead spaces outside the pump chamber or the case. Alternatively, the pump housing or case may have a circular or oval peripheral wall such that it envelopes the circular pump chamber and reduces or eliminates any dead spaces outside the pump chamber or case.

Furthermore, the electronic apparatus according to the present invention is not limited to a portable computer. Rather, the invention may be applied to a PDA (Personal Digital Assistant) and any other type of a data-processing apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a housing that contains a heat-generating component;
a heat-receiving portion thermally connected to the heat-generating component and having a plurality of peripheral walls;
a plurality of fixing areas provided externally of the peripheral walls of the heat-receiving portion;
a plurality of fixing portions arranged around the heat-generating component and aligned with the fixing areas; and
a holding member fastened to the fixing portions and holding the heat-receiving portion in the housing.

2. An apparatus according to claim 1, wherein the peripheral walls are each selected from the group consisting of a straight wall and a curved wall.

3. An apparatus according to claim 1, wherein the heat-receiving portion is octagonal and has eight corners equidistant from each other, and the fixing areas are each positioned between an adjacent two of the corners.

4. An electronic apparatus comprising:
a housing that contains a heat-generating component;
a heat-receiving portion thermally connected to the heat-generating component and having a generally circular peripheral wall;
a plurality of fixing areas provided externally of the circular peripheral wall of the heat-receiving portion;
a plurality of fixing portions arranged around the heat-generating component and aligned with the fixing areas; and
a holding member fastened to the fixing portions and holding the heat-receiving portion in the housing.

5. An apparatus according to claim 4, wherein the generally circular peripheral wall is an oval.

6. An apparatus according to claim 4, wherein the generally circular peripheral wall is a circle.

7. An electronic apparatus comprising:
a housing that contains a heat-generating component;
a heat-receiving portion thermally connected to the heat-generating component;
a heat-radiating portion that radiates heat generated by the heat-generating component;
a coolant-circulating path that circulates liquid coolant between the heat-receiving portion and the heat-radiating portion;
a pump that supplies the coolant to the heat-radiating portion and has a plurality of peripheral walls;
a plurality of fixing areas provided outside the pump, each fixing area being located between two corners defined by an adjacent three of the peripheral walls;
a plurality of fixing portions arranged around the pump and aligned with the fixing areas; and
a holding member fastened to the fixing portions and holding the pump in the housing.

8. An apparatus according to claim 7, wherein the pump is octagonal and has eight corners equidistant from each other, and each of the fixing areas is positioned between two adjacent corners of the pump.

9. An apparatus according to claim 7, wherein the pump has an impeller surrounded by the peripheral walls, and the fixing areas oppose one another across the impeller.

10. An apparatus according to claim 7, wherein the pump has a coolant inlet port and a coolant outlet port formed in one of the peripheral walls.

11. An electronic apparatus comprising:
a housing that contains a heat-generating component;
at least two fixing portions arranged around the heat-generating component and opposing each other across the heat-generating component;
a heat-receiving portion thermally connected to the heat-generating component;
a heat-radiating portion that radiates heat generated by the heat-generating component;
a coolant-circulating path that circulates liquid coolant between the heat-receiving portion and the heat-radiating portion;
a pump formed integrally with the heat-receiving portion that supplies the coolant heated at the heat-receiving portion through the heat-radiating portion, and includes a polygonal pump housing having at least five peripheral walls, wherein two of the peripheral walls oppose each other and lie near the fixing portions; and
a holding member fastened to the fixing portions and holding the pump in the housing.

12. An apparatus according to claim 11, wherein the pump housing is octagonal and has eight peripheral walls being of equal length.

13. An apparatus according to claim 11, wherein the pump housing has a coolant inlet port and a coolant outlet port formed in one of the peripheral walls.

14. An apparatus according to claim 11, wherein the heat-generating component is a circuit component on a printed circuit board, and the pump housing is thermally connected to the circuit component by the heat-receiving portion.

15. An apparatus according to claim 14, wherein the fixing portions include a plurality of stud pins secured to the printed circuit board, and the holding member is elastic, is fastened to the stud pins, and pushes the pump housing and the heat-receiving portion onto the circuit component.

16. An apparatus according to claim 11, wherein the pump has at least five corners, each defined by an adjacent two of the peripheral walls and having an angle greater than a right angle.

17. An electronic apparatus comprising:
a housing that contains a heat-generating component;
a heat-receiving portion thermally connected to the heat-generating component and having a plurality of peripheral walls;
a plurality of fixing areas provided outside the heat-receiving portion, each of the fixing areas being located between two corners defined by an adjacent three of the peripheral walls;
a plurality of fixing portions arranged around the heat-generating component and aligned with the fixing areas; and
a holding member fastened to the fixing portions and holding the heat-receiving portion in the housing.

18. An apparatus according to claim 17, wherein the heat-receiving portion is octagonal and has eight corners equidistant from each other, and the fixing areas are each positioned between an adjacent two of the corners.

19. An apparatus according to claim 17, wherein any one of the peripheral walls near any one of the fixing areas inclines towards two adjacent peripheral walls.

20. An electronic apparatus comprising:
a housing that contains a heat-generating component;
at least two fixing portions arranged around the heat-generating component and opposing each other across the heat-generating component;
a heat-receiving portion thermally connected to the heat-generating component and including a polygonal case having a coolant path and at least five peripheral walls, at least two of the peripheral walls opposing each other across the coolant path and being located near the fixing portions;
a holding member fastened to the fixing portions and holding the heat-receiving portion in the housing;
a heat-radiating portion that radiates heat generated by the heat-generating component; and
a coolant-circulating path that circulates liquid coolant between the heat-receiving portion and the heat-radiating portion.

21. An apparatus according to claim 20, wherein the heat-receiving portion is octagonal and has eight peripheral walls being of equal length.

22. An apparatus according to claim 20, wherein the heat-generating component is a circuit component mounted on a printed circuit board, and the housing has a heat receiving surface thermally connected to the circuit component.

23. An apparatus according to claim 22, wherein the fixing portions are stud pins secured to the printed circuit board, and the holding member is elastic, is fastened to the stud pins, and pushes the housing onto the circuit component.
